(19) United States
(12) Patent Application Publication
(10) Pub. No.: US 2021/0014135 A1
(43) Pub. Date: Jan. 14, 2021

(54) WAN TUNNEL KPI/SLA PREDICTION AND SCHEDULE RECOMMENDER

(71) Applicant: Cisco Technology, Inc., San Jose, CA (US)

(72) Inventor: Chunhui Wong, Santa Clara, CA (US)

(21) Appl. No.: 16/505,384

(22) Filed: Jul. 8, 2019

(51) Int. Cl. H04L 12/24

(52) U.S. Cl. CPC H04L 41/5025; H04L 41/5009

(57) ABSTRACT

The disclosed technology relates to a process for automating an optimized schedule of future application traffic paths on various Virtual Private Networks (VPN) tunnels using different Key Performance Indicators (KPIs) in order to meet the different applications' Service Level Agreements. The schedule is based on first characterizing the performance of different tunnels observed over a period of time. The past performance of the tunnels is then used to predict future performance of the same tunnels using machine learning. A schedule is then generated based on the prediction to transmit content across the network that best satisfies the SLA criteria of the content. The process lowers overall Operation Expenditure (OPEX) related to the cost (e.g. time and resources) of the overall network, improves data flow, and minimizes interruptions.

### TECHNICAL FIELD

The subject matter of this disclosure relates in general to application traffic, and more specifically for a prediction and recommender system that performs proactive traffic engineering and path selection for qualified application performance.

### BACKGROUND

Traditionally, application-based network traffic using a Wide Area Network (WAN) were based on Quality of Service (QoS) and static Service Level Agreement (SLA) configurations of silo-ed network devices and fixed paths. This traditional network arrangement was often slow to setup, were over-provisioned, and merely provided reactive adjustments via switchover only after SLA criteria violations were detected. With the advent of Software Defined Networks (SDN), there is increasing demand for dynamic traffic engineering such that application and service traffic can flow more smoothly with fewer disruptions.

### BRIEF DESCRIPTION OF THE FIGURES

In order to describe the manner in which the above-recited and other advantages and features of the disclosure can be obtained, a more particular description of the principles briefly described above will be rendered by reference to specific embodiments that are illustrated in the appended drawings. Understanding that these drawings depict only embodiments of the disclosure and are not therefore to be considered to be limiting of its scope, the principles herein are described and explained with additional specificity and detail through the use of the accompanying drawings in which:

FIG. 1 is a conceptual block diagram illustrating an example network environment in accordance with various embodiments of the subject technology;

FIG. 2A-FIG. 2E shows example key performance identifier comparisons associated with network-based predictions;

FIG. 3 shows example proactive scheduler predictions;

FIG. 4 shows an example proactive scheduler taking into account the key performance identifiers of two different tunnels;

FIG. 5 shows an example proactive schedule based on characterization of two tunnels;

FIG. 6 shows another example proactive schedule based on characterization of three tunnels.

FIG. 7 shows an example method for the proactive scheduler;

FIG. 8 illustrates an exemplary network device in accordance with various embodiments of the subject technology; and

FIG. 9 shows an example computing system in accordance with various embodiments of the subject technology.

### BRIEF DESCRIPTION OF EXAMPLE EMBODIMENTS

The detailed description set forth below is intended as a description of various configurations of embodiments and is not intended to represent the only configurations in which the subject matter of this disclosure can be practiced. The appended drawings are incorporated herein and constitute a part of the detailed description. The detailed description includes specific details for the purpose of providing a more thorough understanding of the subject matter of this disclosure. However, it will be clear and apparent that the subject matter of this disclosure is not limited to the specific details set forth herein and may be practiced without these details. In some instances, structures and components are shown in block diagram form in order to avoid obscuring the concepts of the subject matter of this disclosure.

### Overview

Disclosed herein are computer-implemented methods, computer-readable media, and systems for proactively scheduling traffic in a network. The proactive scheduling first involves characterization of the performance quality for each of the different network routes within the network. Once the performance quality for each of the routes is characterized for a pre-determined period of time, a prediction is generated for the network. The prediction identifies trends associated with the performance quality of the different network routes within the network. Content data is then received to be transmitted using the network. The content data has a corresponding service level agreement (SLA) criteria that needs to be satisfied. Based on the prediction and the content data, a delivery is scheduled that identifies a subset of network routes that can be used to transmit the content data using the network that satisfies the SLA criteria.

In another embodiment, the performance quality for the different network routes is based on different key performance indicator (KPI) parameters. Example KPI parameters that are used include one or more of jitter, loss, and latency.

In another embodiment, the characterization of the performance quality of the different network routes is performed by monitoring the different network routes over the period of time based on the one or more KPI parameters, identifying a performance for each of the different routes based on the one or more KPI parameters, and aggregating the performance of the routes such that a characterization of the performance quality of a is based on a highest content that can be satisfied for each of the KPI parameters used.

In another embodiment, the SLA criteria corresponds to different classes of content each having a requisite performance requirement. A first class has the strictest requisite performance requirement and each subsequent class has less strict requisite performance requirement with respect to a previous class.

In another embodiment, detection of an anomaly in the network can also be performed. The anomaly causes one or more of the network routes associated with the scheduled delivery of the content to no longer satisfy the SLA criteria associated with the content. In this case, the scheduled delivery can be updated to identify a different subset of network routes that are used to transmit the content that satisfies the SLA criteria associated with the content.

In another embodiment, the predictions regarding the performance quality for each of the different network routes can be generated using machine learning.

### Example Embodiments

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

As described herein, the present disclosure covers a proposed solution for application and network traffic by implementing a recommendation system that can be easily used and understood by its users (e.g operator, support personnel). The recommendation system automates an optimized schedule of future application traffic paths on various Virtual Private Networks (VPN) tunnels using different Key Performance Indicators (KPIs) in order to meet the different applications' Service Level Agreements. In doing so, the recommendation system can lower overall Operation Expenditure (OPEX) related to the cost (e.g time and resources) of the overall network. Details for carrying out the recommendation system will be provided below in connection with the figures and associated disclosure.

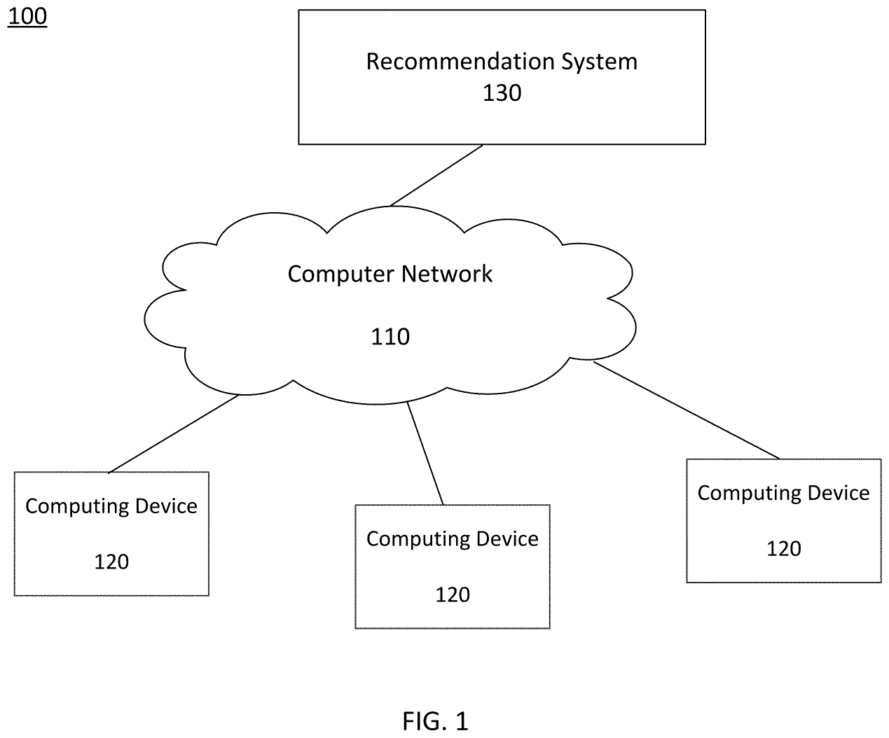

FIG. 1 is a conceptual block diagram illustrating an example network environment 100 in accordance with various embodiments of the subject technology. The example network environment 100 includes a computer network 110 (e.g. Wide Area Network, Software Defined Wide Area Network) that is used to transmit data packets associated with computing devices 120. The data packets may be associated with applications that are being transmitted from the computing device 120 to another computing device or server using the computer network 110. The recommendation system 130 is used to observe the computer network 110 and generate an optimized schedule for transmitting the data coming from the computing devices 120. The optimized schedule generated by the recommendation system 130 takes into account the SLA criteria associated with the data coming from the computing devices 120 so as to maintain a level of quality for the user. The optimized schedule is also generated in advanced so that the data can be transmitted from the computing device 120 using the best possible predicted route through the computer work 110 thereby minimizing interruptions and improving data flow.

In order to generate the optimized schedule that is used for the transmission of application data from the computing devices 120 on the computer network 110, the recommendation system 130 monitors the performance of the various tunnels associated with the computer network 110 over a period of time. The performance of each tunnel over the monitored period of time is characterized based on one or more different KPIs (e.g. loss, jitter, latency). Based on the characterization of the different tunnels associated with the computer network 110, the recommendation system 130 then knows what tunnels can satisfy certain performance criteria at specific points in time. Based on the application data (and associated SLA criteria) being transmitted from the computing device 120, the recommendation system 130 proactively selects a subset of the tunnels to transmit the application data and proactively schedule use of those tunnels for the application data.

In addition, the recommendation system 130 continues the monitor the status of the computer network 110 in real time in order to also implement any real-time changes as needed for the transmission of the application data from the computing device 120. For example, if certain tunnels within the computer network 110 experience anomalies in performance (e.g. outage) that were not originally predicted, the recommendation system 130 can still perform a reactive re-scheduling of the application data using different tunnels that are currently available in order to continue the transmission of the application data.

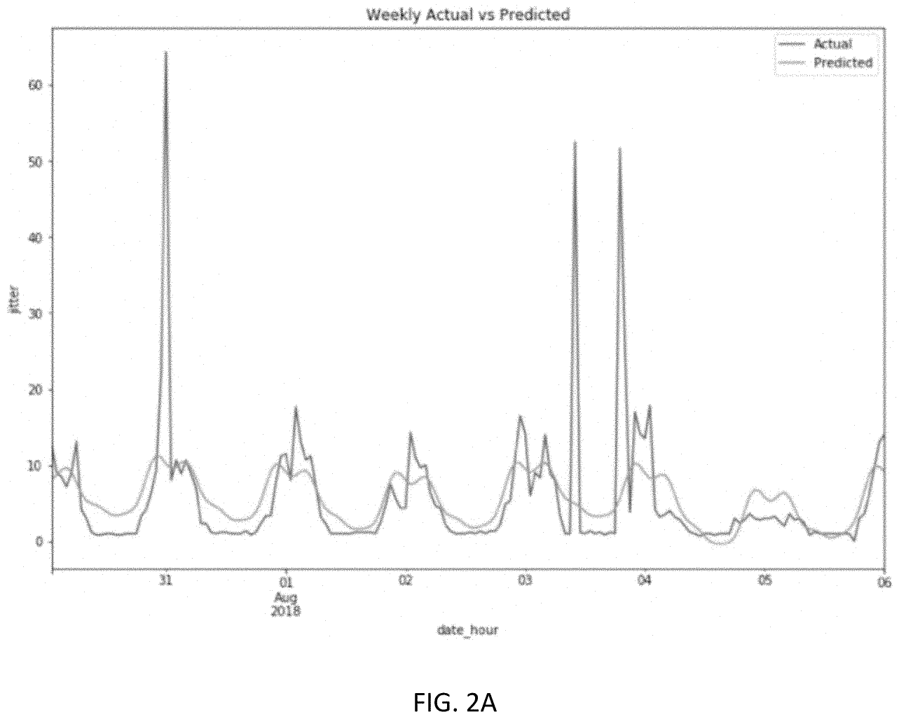

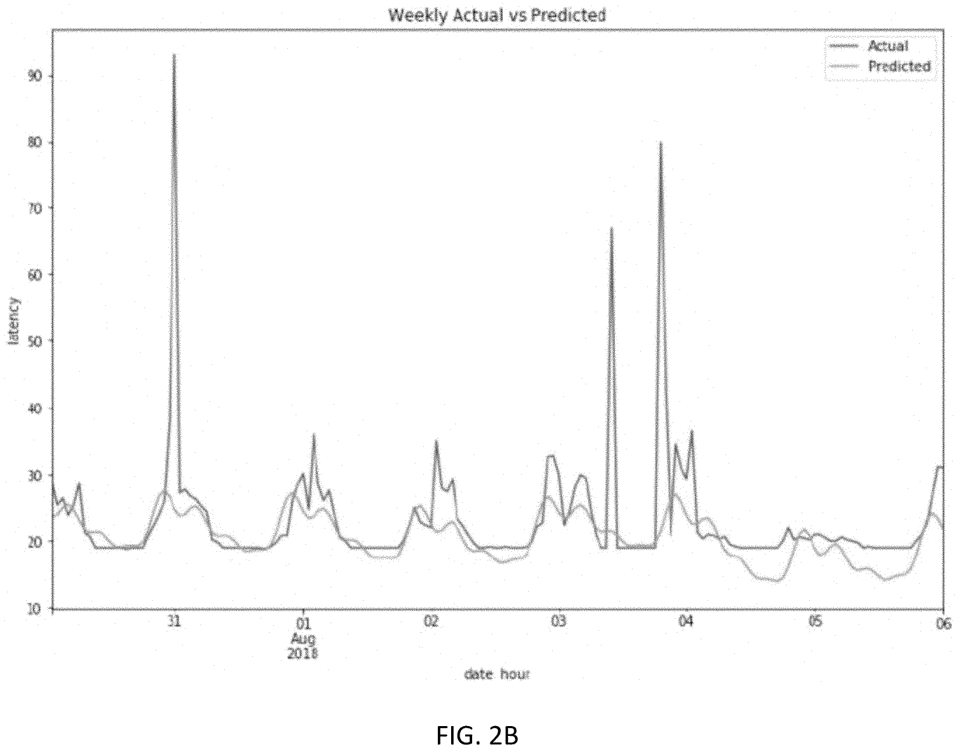

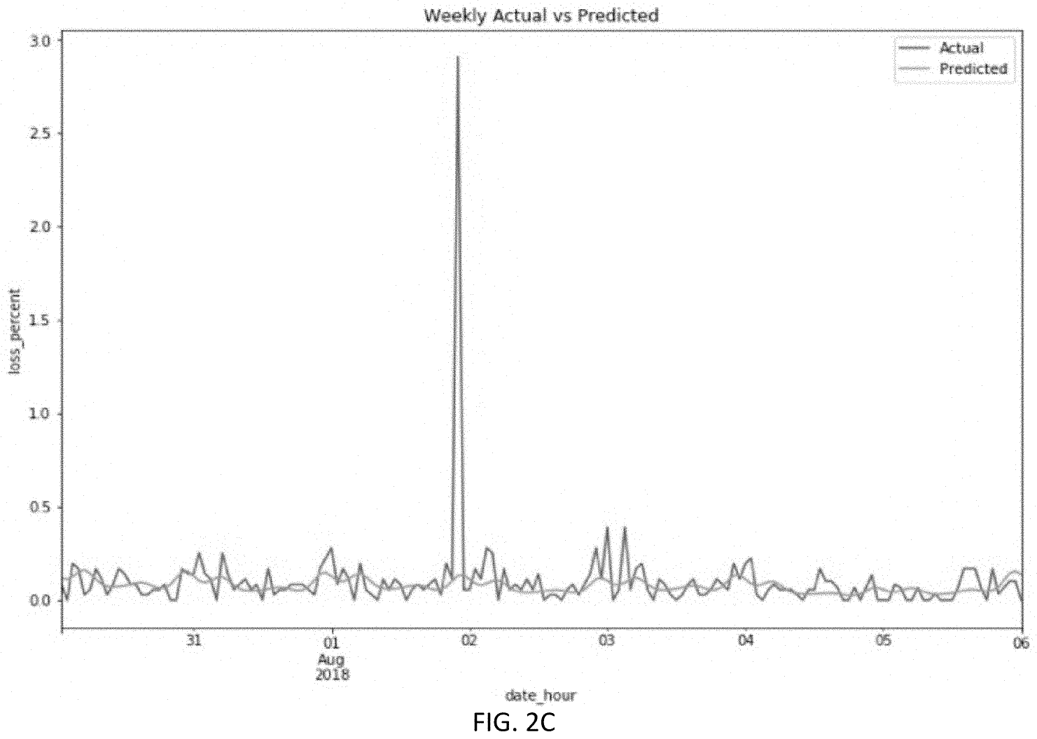

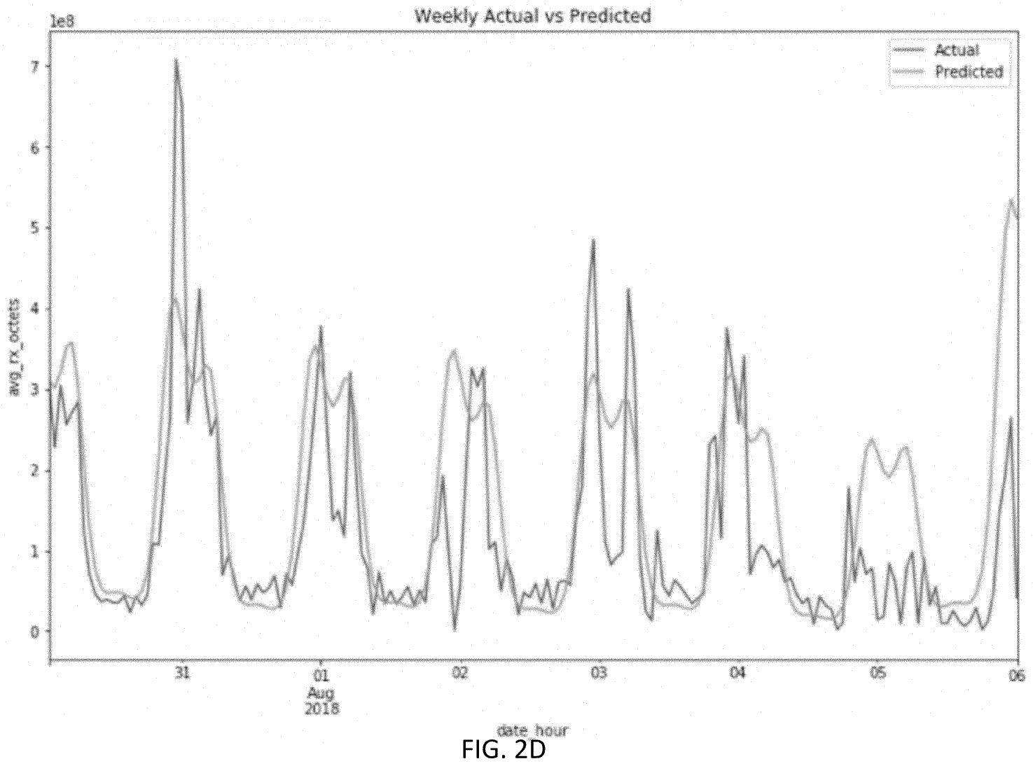

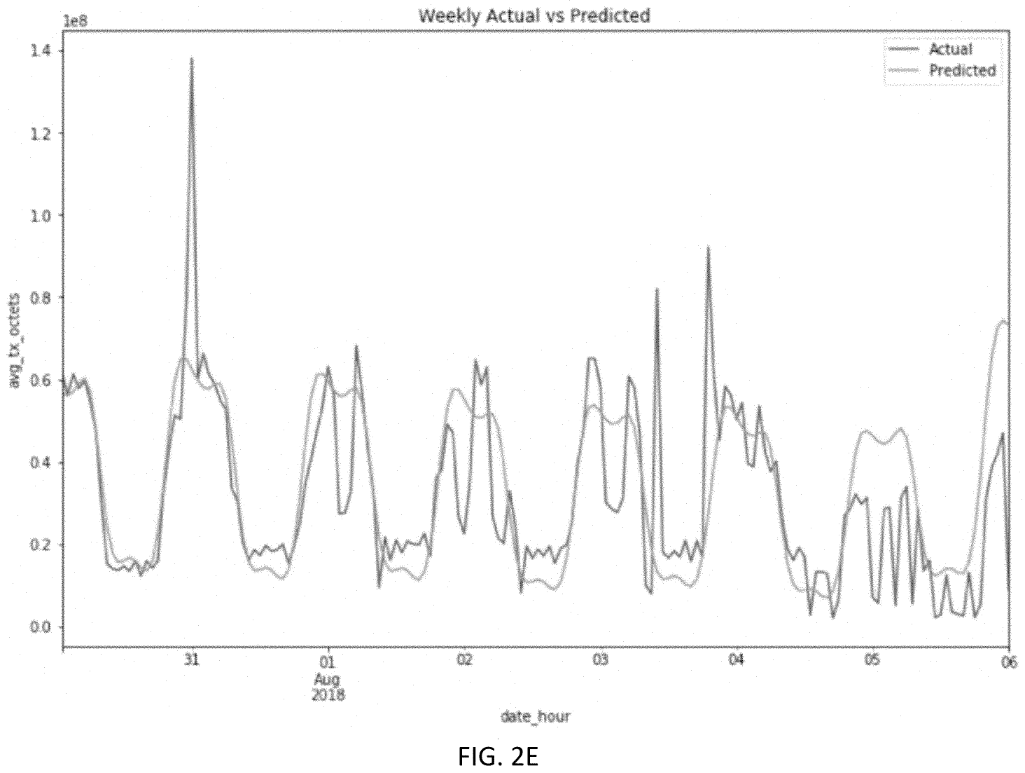

FIG. 2A-FIG. 2E shows example key performance identifier comparisons associated with network-based predictions. In each of the figures, a comparison between actual computing network performance and predicted measurements associated with a key performance identifier are illustrated. The predictions made by the recommendation system are based on monitoring of the computing network for a pre-determined period of time. A machine learning process implemented by the recommendation system can generate predictions that are characterizations on the future performance of the computing network based on past performance. Each of the figures then illustrates the similarities between the predictions that have been made by the recommendation system with the actual network performance associated with the corresponding key performance indicator.

FIG. 2A illustrates a comparison between actual and predicted jitter levels experienced in the computing network. FIG. 2B illustrates a comparison between actual and predicted latency levels experienced in the computing network. FIG. 2C illustrates a comparison between actual and predicted loss percentage levels experienced in the computing network. FIG. 2D and FIG. 2E illustrates a comparison between actual and predicted averages of data being received and transmitted across the computing network, respectively.

As illustrated in the figures, the predictions made via the machine learning process implemented by the recommendation system are close to the actual measured performance of the tunnels across a particular key performance identifier. Although there may be some anomalies, the anomalies could correspond to situations that are not normally predictable (e.g. network outages). By not considering the anomalies, a general trend can be observed and the machine learning process can use the general trend to characterize performance of the computing network, and specifically characterize performance of the different tunnels (and even portions of the different tunnels) associated with the computing network.

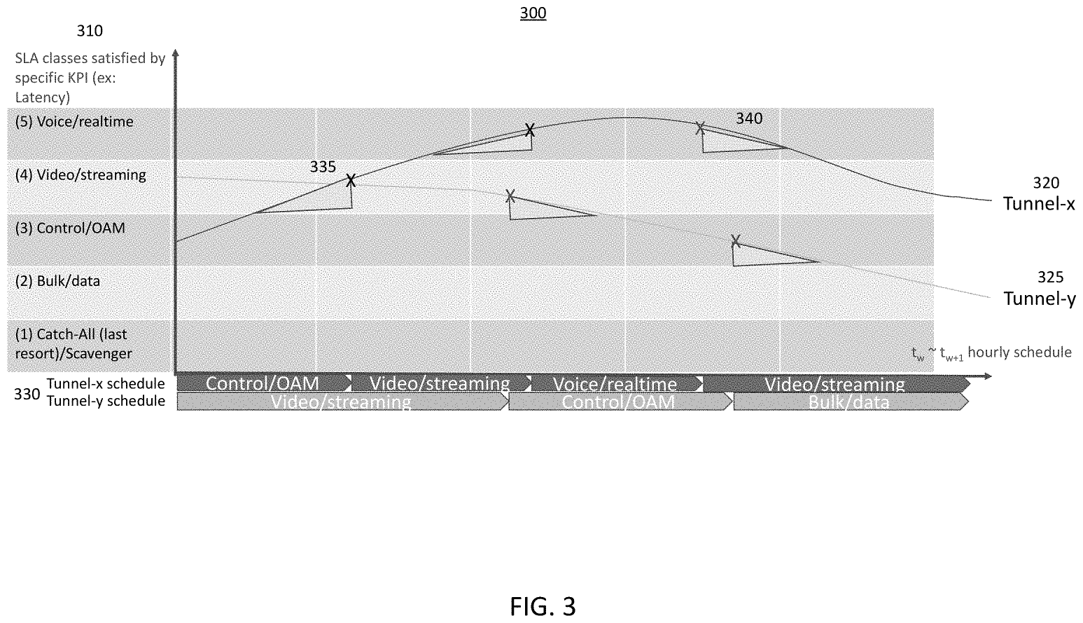

FIG. 3 shows example proactive scheduler predictions 300. In particular, the predictions 300 are used to identify what content can be sent across which tunnel during certain periods of time.

As illustrated in the figure, the example prediction 300 is a graph that illustrates a performance of two different tunnels (e.g., tunnel-x 320 and tunnel-y 325) over a period of time (measured on an hourly schedule). The prediction 300 characterizes the performance of the two different tunnels 320, 325 based on an SLA “class” 310 that can be satisfied according to one or more key performance indicators.

A SLA “class” 310 corresponds to different groups of content that have similar SLA criteria. As illustrated in the figure, there may be 5 exemplary types of “classes.” Each “class” of content may have a requisite quality that corresponds to the transmission of the content. In other embodiments, more or less different types of “classes” of content may be used.

One type of content that can be transmitted over the computer network may include voice or real-time content. This type of content (since it is located on the top of the SLA “class” chart) may have the highest or strictest SLA criteria requirements (e.g. lowest latency allowed, lowest packet loss allowed). Going down from voice or real-time content, the other “classes” of content may have less strict SLA criteria requirements compared to the preceding “class” of content. For example, the figure also includes video and streaming content, control and Operations, Administration and management (OAM) content, and bulk data. There may even be a lowest group that is a catch all for any other content that doesn't fall in the four higher “classes” of content. This lowest group may have the minimal requirement for transmitting data using the computer network.

Each of the lines associated with the performance of the tunnels 320, 325 correspond to a level of SLA criteria that can be satisfied at certain points in time. For example, at point 335, tunnel-X 320 is capable of satisfying the SLA criteria requirements associated with video and streaming content. At a later point in time, at point 340, the same tunnel-x 320 is capable of satisfying a higher SLA criteria requirement associated with voice and real-time content. In a similar manner, a line associated with tunnel-y 325 is used to illustrate the performance of the tunnel over a period of time.

By using the lines associated with each of the tunnels (e.g. tunnel-X 320 and tunnel-y 325), content can be scheduled using one or both of the tunnels based on the SLA criteria requirements that can be satisfied by that tunnel. For example, up to point 335, it would be possible for tunnel-x 320 to be used to transmit any content that has SLA criteria requirements as strict as video and streaming content or any content that has less strict requirements than video or streaming content (e.g. control and OAM content). Tunnels that are capable of providing a higher quality of performance than what is required by the SLA requirement can be used (e.g. using tunnel-x 320 to transmit control/OAM content even though the performance of the tunnel-x 320 is capable of supporting video and streaming content).

However, there is a need to monitor the prediction to determine if there are any significant changes in performance that could potentially degrade the performance of the tunnel thereby affecting the type of content that can be transmitted using that tunnel for a period of time. Points 335 and 340 in the figure illustrate two different situations where the changes in performance are present in the tunnel. With point 335, the performance of the tunnel improves over a period of time. This improvement can be detected by monitoring the performance of a tunnel over a period of time and identifying that the performance actually improves over the period of time. This change in performance of the tunnel does not impose any possible negative effect on the content being transmitted since it is possible to use tunnels that can satisfy higher “classes” of content in transmit a lower “class” of content. However, identification of an improvement in performance of a tunnel can be used to schedule/re-schedule higher “class” of content to be transmitted if there are no other tunnels possible of transmitting the higher “class” of content.

In contrast, point 340 corresponds to the performance of the tunnel that degrades over a period of time. Whereas an improvement of the performance of the tunnel does not impose any possible negative effects on the content being transmitted, the degrading of the tunnel over a period of time may potentially cause the tunnel to no longer be capable of satisfying an SLA criteria requirement. For example, if performance of the tunnel (e.g. tunnel-y 325) is initially identified as satisfying video and streaming content but the performance degrades down to satisfying control or OAM content, there is a possibility that the tunnel transmitting video and streaming content will experience issues with the transmission of the content when a lower SLA criteria requirement is being used for a higher “class” of content.

For situations where the performance of the tunnel degrades, there may be a choice to degrade the characterization of the tunnel to a lower “class” to ensure that the tunnel can be used to properly transmit content. For example, at point 340, even though the tunnel-x 320 can currently accommodate voice and real-time content, it may be desirable to characterize during that same period of time the performance of tunnel-x 320 to a lower level (e.g. video and streaming content).

By using the predictions 300 as illustrated in the figure for tunnel-x 320 and tunnel-y 325, a schedule 330 can be generated. The schedule 330 identifies a type of content that will be transmitted (based on the associated SLA criteria requirement) across the two tunnels and the time period for which the tunnel will be used in the transmission of the content. The schedule 330 will only select the tunnel that is capable of transmitting a particular content and satisfies the SLA criteria requirement for the content during transmission.

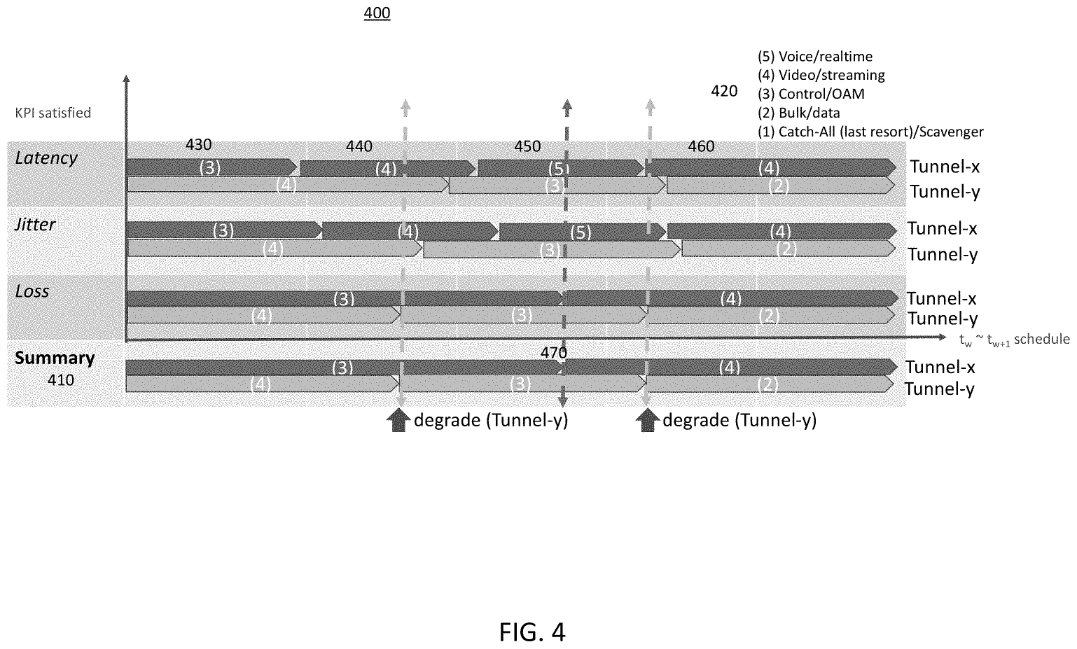

FIG. 4 shows an example proactive scheduler 400 taking into account the key performance identifiers of two different tunnels. As discussed above in connection with FIG. 3, a schedule that utilizes a tunnel to transmit content needs to ensure that the tunnel is capable of transmitting the content and satisfying the associated SLA criteria requirement. To this end, FIG. 4 shows how the performance of a tunnel (e.g. summary 410) is characterized based on its aggregated performance associated with different key performance indicators (e.g., latency, jitter, loss). In other words, the analysis of the tunnel across the different key performance indicators can be used to provide an overall characterization of the performance of the tunnel. This overall characterization would be used during scheduling in order to ensure that the tunnel (when selected/scheduled) is capable of satisfying the SLA criteria requirement for the content being scheduled.

Similar to the previous figure, there are different categories or “classes” of content 420 each with different SLA criteria requirements. For example, voice and real-time content may have the highest or strictest SLA criteria requirement (denoted as ‘5’ in the figure) with each other category or “class” numerically smaller having less strict SLA criteria requirement (e.g. video and streaming content denoted as ‘4’ in the figure).

In a first step, the tunnel performance is characterized with respect to each of the different key performance indicators. For example, with respect to tunnel-x, the performance of the tunnel is illustrated with respect to latency, jitter, and loss. The numbers identify the category or “class” of content that the tunnel would be capable of transmitting and still satisfy the corresponding SLA criteria requirement.

As illustrated in the figure, tunnel-x (with respect to latency) would be able to transmit control and OAM content during a first period of time 430, transmit video and streaming content during a second and fourth period of time 440, 460, and voice and real-time content during a third period of time 450. Similar characterization for tunnel-x would be performed for jitter and loss.

The performance of tunnel-x (e.g. summary 410) would be based on the aggregation of the performance of the tunnel across the different key performance indicators. At each point in time, the lowest characterization (across the different key performance indicators) is used to define at what SLA criteria requirement the tunnel is capable of satisfying because we want to ensure that the tunnel is able to satisfy all SLA criteria requirements regardless of the key performance indicator. As illustrated in the figure, the overall characterization of tunnel-x 410 (as illustrated in the summary 410) is that for the first portion is only capable of satisfying at best the SLA criteria requirement for control and OAM content (up until point 470). That is because the performance of tunnel-x with respect to loss is only capable of satisfying at beast the SLA criteria requirement for control and OAM content even though the performance for tunnel-x may be at some points better with respect to latency and jitter (which has portions that can satisfy “class” 4 and 5 content).

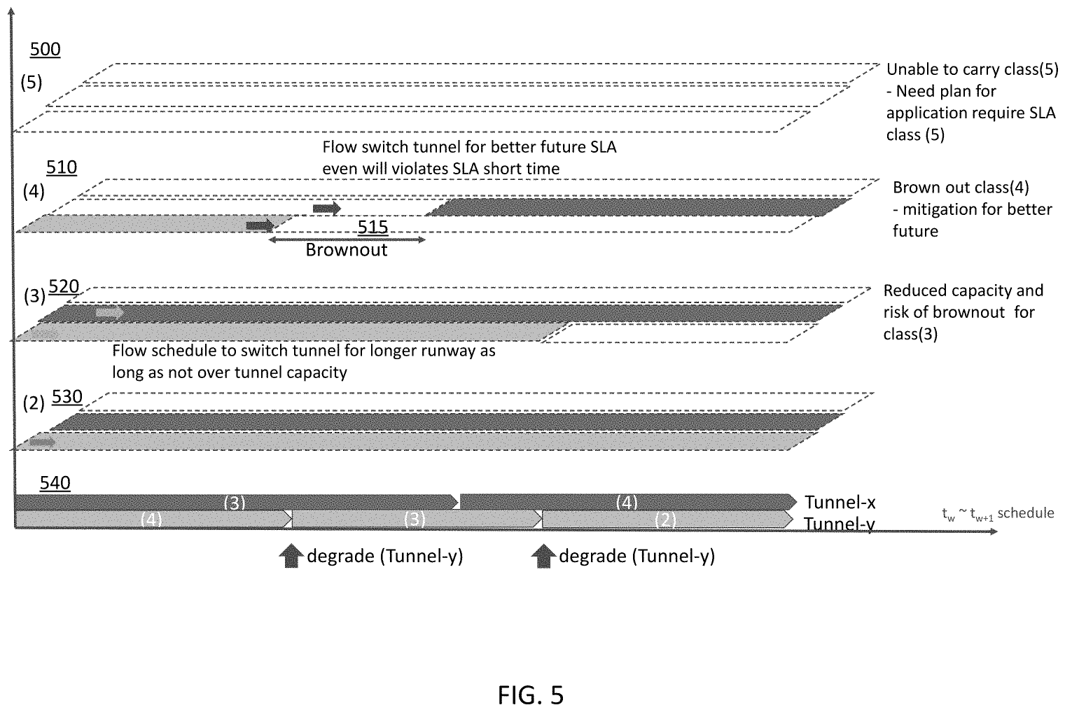

FIG. 5 shows an example proactive schedule based on characterization of two tunnels. The figure illustrates a summary performance of each of the tunnels (e.g. tunnel-x and tunnel-y) in connection with when the tunnel is able to satisfy certain “class” of content associated with corresponding SLA criteria requirements. With respect to 500, both tunnels are unable to satisfy SLA criteria requirements associated with “class” 5 content. With respect to 510, the highlighted portions identify when each of the tunnels can be used to transmit “class” 4 content. However, it should be noted that there is a period of time (associated with 515) in which neither tunnel-x nor tunnel-y is capable of transmitting “class” 4 content. This period of time is known as a brownout. Brownouts are not desirable as this would correspond to a situation where an interruption to the quality of service in the transmission of the “class” 4 content would occur since neither available tunnel could be used to satisfy the SLA criteria requirement. In order to avoid the brownout scenario, it may be desired to downgrade the characterization of the performance of tunnels to “class” 3 520. With respect to 520, the entirety of tunnel-x and most of tunnel-y can be used to transmit “class” 3 content. With respect to 530, both tunnel-x and tunnel-y can be used to transmit “class” 2 content for the entire period of time.

With respect to 540, the figure illustrates a characterization of the performance for each of the respective tunnels. In particular, the characterization identifies the highest performance each tunnel is capable of performing at certain periods in time. By combining the performance of tunnel-x illustrated in 510 and 520, the overall characterization provided in 540 shows that a first period of time the tunnel-x is able to transmit “class” 3 content. At a later point in time, the characterization in 540 shows that tunnel-x can also be used to transmit “class” 4 content. A similar analysis is provided for tunnel y in 540 which shows (based on the combination of 510-530) the periods of time in which tunnel-y can be used to transmit “class” 4, “class” 3, and “class” 2 content.

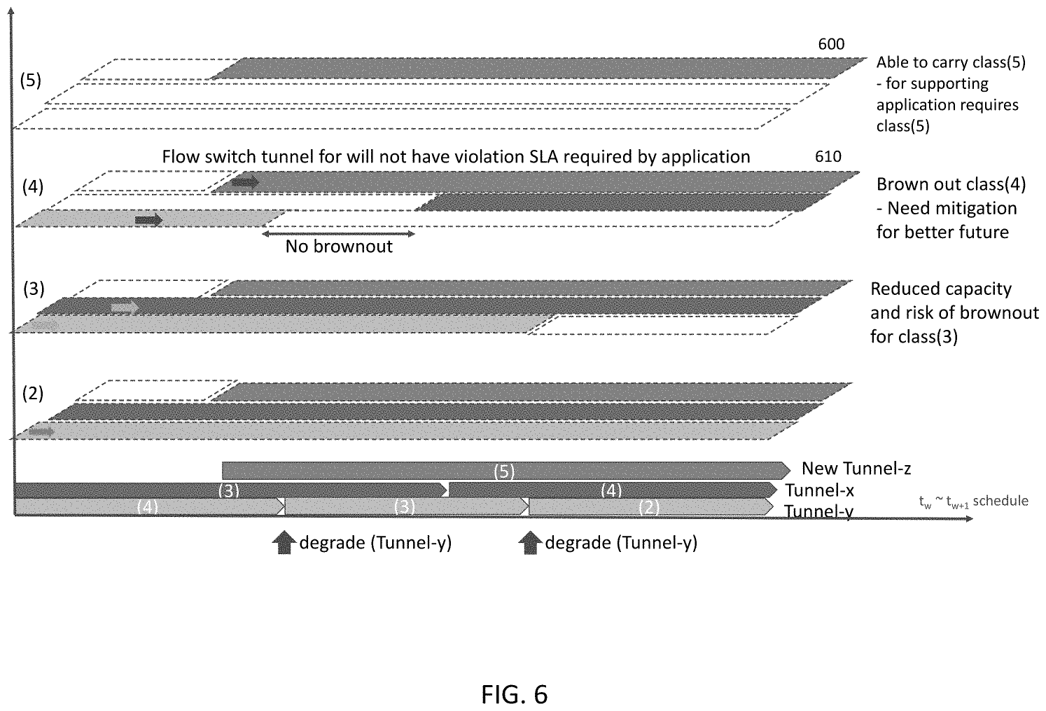

FIG. 6 shows another example proactive schedule based on characterization of three tunnels. In particular, in order to remove the brownout scenario described in FIG. 5, a new tunnel (tunnel-z) is added. Tunnel-z (as illustrated in 600) is able to transmit “class” 5 content for a period of time. With respect to 610, tunnel-z (since it is able to transmit “class” 5 content for the period of time) is also able to transmit “class” 4 content for the same period of time. This period of time, as illustrated in 610, overlaps the period of time where the brownout scenario occurred in FIG. 5. Because the new tunnel-z is now usable during the period of time in which neither tunnel-x and tunnel-y could transmit “class” 4 content (as previously described in FIG. 5), the brownout scenario is removed since the scheduler can now utilize/schedule tunnel-z as a possible tunnel in transmitting the “class” 4 content.

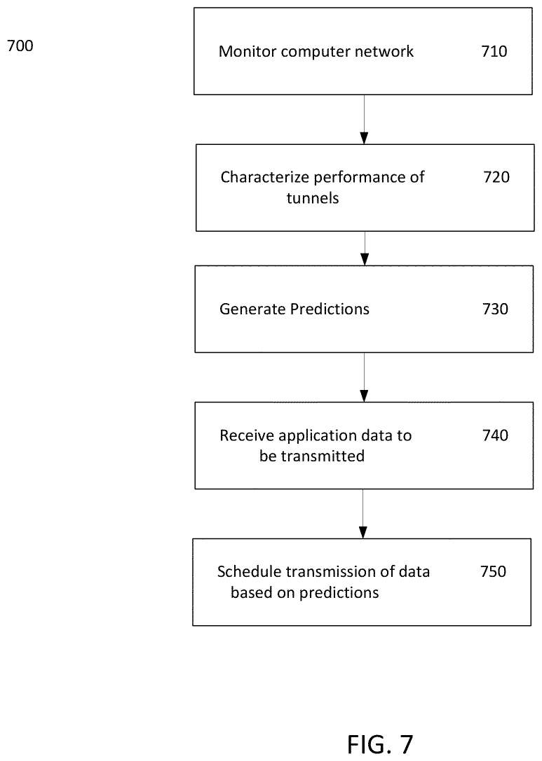

FIG. 7 shows an example method 700 for the proactive scheduler. As discussed above, the present disclosure covers a proactive scheduler that is implemented by the recommendation system illustrated in FIG. 1. As opposed to reactively scheduling the transmission of data whenever issues within a computer network is detected, the proactive scheduler schedules the transmission of application data across the computer network based on prior knowledge of how the computer network operates. The prior knowledge allows the recommendation system to characterize the performance of the tunnels over a period of time and generate predictions of future performance of the same tunnels. Based on the predictions, the recommendation system can identify a subset of tunnels that would satisfy the SLA criteria requirements for transmitting application data cross the computer network and schedule use of those tunnels. In performing the proactive scheduling, the recommendation system aims to improve data flow and minimize the interruptions to the data caused by real-time reactive scheduling.

In step 710, the computer network is monitored. In an embodiment, the computer network is monitored by a recommendation system that is responsible for proactively scheduling the application data coming from the various computing devices connected to the computer network. The monitoring performed in this step looks at the tunnels used in connection with the computer network in transmitting application data across the computer network. The tunnel performance can be monitored based on various key performance indicators (such as jitter, loss, latency). The monitoring step is performed for a period of time so that enough data can be collected so that a machine learning algorithm can be used to later characterize the monitored performance of the tunnels and make predictions as to the future performance of the same tunnels.

In step 720, the performance of the tunnels is characterized based on the monitoring done in step 710. As described in FIG. 4, the performance of a tunnel can be monitored based on a number of different key performance indicators. The data for each of the key performance indicators is aggregated in order to generate an overall performance characterization of the tunnel. The characterization of the performance of the tunnel needs to be based on the lowest quality performance associated with one or more key performance indicators in order to ensure that SLA criteria requirements for all key performance indicators can be met.

In step 730, predictions for the computer network are generated. The predictions correspond to future performance of the tunnels associated with the computer network based on the monitoring and characterizations of past performance of the same tunnels performed in step 710 and step 720. The predictions are generated using machine learning and can be updated as more data is obtained about the computer network. The predictions are used in the scheduling of tunnels chosen to transmit the data packets from computing devices connected to the computer network. The predictions identify which tunnels are able to satisfy the SLA criteria requirements of the data packets in order to ensure consistent data flow and minimize the interruptions that could negatively affect the quality service and user experience.

In step 740, information about the application data that to be transmitted through the computer network is received. The application data information may include corresponding SLA criteria requirements that highlight a level of quality of service that the user would like to have (e.g. latency less than a pre-determined value). This information will be used with the generated predictions in order to identify a subset of tunnels associated with the computer network to use in the transmission of the data.

In step 750, the proactive schedule is generated. The tunnels chosen for the schedule will be based on the prediction that the performance of the scheduled tunnels would be able to transmit the data while satisfying the associated SLA criteria requirement.

There may be, however, situations where anomalies (e.g., unexpected occurrences) are detected within the computer network. These anomalies can be detected at a time prior to the scheduled transmission of the data or while the data is being transmitted. For example, there may be some outages associated with various nodes within the computer network that would negatively impact the performance of one or more tunnels that do not correspond to the predictions previously made. In either case, adjustments to the schedule can be made to address the issues raised by the anomalies. The predictions can still be used to identify other tunnels that could be used in place of the one or more tunnels affected by the anomaly.

In situations where no available tunnel can be detected that satisfy the SLA criteria requirement for the data, a notification can be provided to the user indicating that the computer network may be incapable of transmitting the data with the associated SLA criteria requirement. A user can be requested input regarding preference of whether the data should be scheduled for transmission at a later time (in order to maintain the SLA criteria requirement) or to update and/or continue transmission of the data despite network anomalies knowing that the SLA criteria requirement may not be met during the entire transmission. If the user provides a preference that the transmission of the data can be delayed, the data can then be scheduled for a later transmission, potentially after the computer network has addressed the anomaly. If transmission of the data is requested immediately, however then a schedule can be generated or updated that selects one or more tunnels that does its best to satisfy the SLA criteria requirement. However, the latter choice requires that the user concede the possibility that there may be portions of time where the SLA criteria requirement cannot be met.

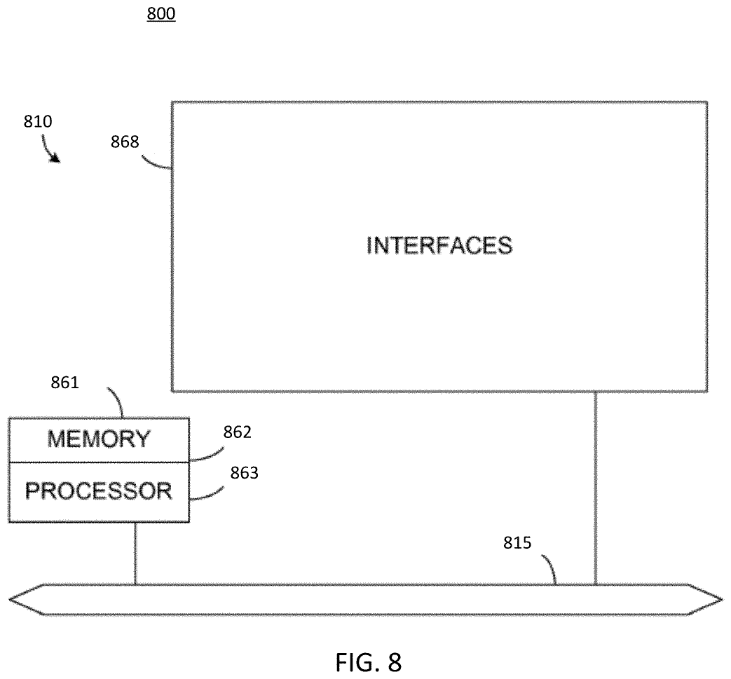

FIG. 8 illustrates an exemplary network device 800 in accordance with various embodiments of the subject technology. Network device 810 includes a master central processing unit (CPU) 862, interfaces 868, and a bus 815 (e.g., a PCI bus). When acting under the control of appropriate software or firmware, the CPU 862 is responsible for performing the steps illustrated in FIG. 7. The CPU 862 preferably accomplishes all these functions under the control of software including an operating system and any appropriate applications software. CPU 862 may include one or more processors 863 such as a processor from the Motorola family of microprocessors or the MIPS family of microprocessors. In an alternative embodiment, processor 863 is specially designed hardware for controlling the operations of router 810. In a specific embodiment, a memory 861 (such as non-volatile RAM and/or ROM) also forms part of CPU 862. However, there are many different ways in which memory could be coupled to the system.

The interfaces 868 are typically provided as interface cards (sometimes referred to as “line cards”). Generally, they control the sending and receiving of data packets over the network and sometimes support other peripherals used with the router 810. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 862 to efficiently perform routing computations, network diagnostics, security functions, etc.

Although the system shown in FIG. 8 is one specific network device of the present embodiments, it is by no means the only network device architecture on which the present embodiments can be implemented. For example, an architecture having a single processor that handles communications as well as routing computations, etc. is often used. Further, other types of interfaces and media could also be used with the router.

Regardless of the network device's configuration, it may employ one or more memories or memory modules (including memory 861) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc.

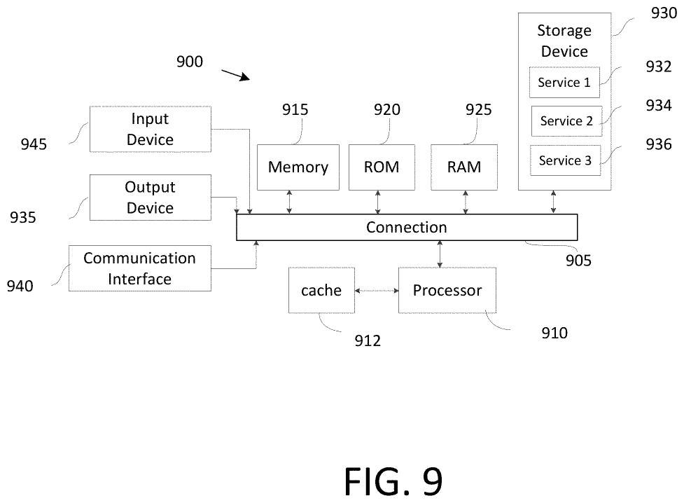

FIG. 9 shows an example computing system 900 in accordance with various embodiments of the subject technology. The example computing device can correspond to any of the computing devices or the recommendation system as illustrated in FIG. 1. Furthermore, the example computing device may also make up any component thereof in which the components of the system are in communication with each other using connection 905. Connection 905 can be a physical connection via a bus, or a direct connection into processor 910, such as in a chipset architecture. Connection 905 can also be a virtual connection, networked connection, or logical connection.

In some embodiments computing system 900 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example system 900 includes at least one processing unit (CPU or processor) 910 and connection 905 that couples various system components including system memory 915, such as read only memory (ROM) 920 and random access memory (RAM) 925 to processor 910. Computing system 900 can include a cache of high-speed memory 912 connected directly with, in close proximity to, or integrated as part of processor 910.

Processor 910 can include any general purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms known to those of skill in the art. In some instances, multimodal systems can enable a user to provide multiple types of input/output to communicate with computing system 900. Computing system 900 can include communications interface 940, which can generally govern and manage the user input and system output. There is no restriction on operating on any particular hardware arrangement and therefore the basic features here may easily be substituted for improved hardware or firmware arrangements as they are developed.

Storage device 930 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 930 can include software services, servers, services, etc., that when the code that defines such software is executed by the processor 910, it causes the system to perform a function. In some embodiments, a hardware service that performs a particular function can include the software component stored in a computer-readable medium in connection with the necessary hardware components, such as processor 910, connection 905, output device 935, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A method for proactively scheduling traffic in a network, the method comprising:
characterizing performance quality for each of a plurality of different network routes for a pre-determined period of time;
generating a prediction based on the characterizing of the performance quality for each of the plurality of different network routes, and the prediction identifying trends associated with the performance quality of the different network routes;
receiving content data to be transmitted using the network, the content data including corresponding service level agreement (SLA) criteria; and
scheduling a delivery of the content data based on the prediction, the delivery identifying a subset of network routes used to transmit the content data that satisfies the SLA criteria of the content data.

2. The method of claim 1, wherein the performance quality for each of the plurality of different network routes is based on key performance indicator (KPI) parameters.

3. The method of claim 2, wherein the KPI parameters include one or more of jitter, loss, or latency.

4. The method of claim 3, wherein the characterizing of the performance quality of the different network routes comprises:
monitoring the different network routes over the pre-determined period of time based on the KPI parameters;
identifying a performance for the different network routes over the pre-determined period of time based on each of the KPI parameters; and
aggregating the performance of the different network routes over the pre-determined period of time, the characterizing of the performance quality based on a highest class of content and the corresponding SLA criteria that is satisfied for each of the KPI parameters used.

5. The method of claim 1,
wherein;
the SLA criteria correspond to different classes of content each having a requisite performance requirement,
a first class has a strictest requisite performance requirement, and
each subsequent class has a less strict requisite performance requirement with respect to a previous class.

6. The method of claim 1, further comprising:
detecting an anomaly in the network, the anomaly causing one or more of the plurality of different network routes associated with the delivery of the content data to no longer satisfy the SLA criteria.

7. The method of claim 6, further comprising:
updating the delivery to identify a different subset of network routes used to transmit the content data to satisfy the SLA criteria of the content data.

8. A non-transitory computer-readable medium comprising instructions for proactively scheduling traffic in a network, the instructions, when executed by a computing system, cause the computing system to:
characterize performance quality for each of a plurality of different network routes for a pre-determined period of time;
generate a prediction based on the performance quality for each of the plurality of different network routes, and the prediction identifying trends associated with the performance quality of the plurality of different network routes;
receive content data to be transmitted using the network, the content data including corresponding service level agreement (SLA) criteria; and
schedule a delivery of the content data based on the prediction, the delivery identifying a subset of network routes used to transmit the content data that satisfies the SLA criteria of the content data.

9. The non-transitory computer-readable medium of claim 8, wherein the performance quality for each of the plurality of different network routes is based on key performance indicator (KPI) parameters.

10. The non-transitory computer-readable medium of claim 9, wherein the KPI parameters include one or more of jitter, loss, or latency.

11. The non-transitory computer-readable medium of claim 10, wherein characterizing of the performance quality of the plurality of different network routes comprises:
monitoring the plurality of different network routes over the pre-determined period of time based on the KPI parameters;
identifying a performance for the plurality of different network routes over the pre-determined period of time based on each of the KPI parameters; and
aggregating the performance of the plurality of different network routes over the pre-determined period of time, characterizing the performance quality based on a highest class of content and the corresponding SLA criteria that is satisfied for each of the KPI parameters used.

12. The non-transitory computer-readable medium of claim 8,
wherein,
the SLA criteria correspond to different classes of content each having a requisite performance requirement,
a first class has a strictest requisite performance requirement, and
each subsequent class has a less strict requisite performance requirement with respect to a previous class.

13. The non-transitory computer-readable medium of claim 8, wherein instructions further comprise:
detecting an anomaly in the network, wherein the anomaly causes one or more of the plurality of different network routes associated with the delivery of the content data to no longer satisfy the SLA criteria; and
updating the delivery to identify a different subset of network routes used to transmit the content data to satisfy the SLA criteria of the content data.

14. A system for proactively scheduling traffic in a network, the system comprising:
a processor; and
a non-transitory computer-readable medium storing instructions that, when executed by the system, cause the system to:
characterize performance quality for each of a plurality of different network routes for a pre-determined period of time;
generate a prediction of the network, the prediction based on the performance quality for each of the plurality of different network routes, the prediction identifying trends associated with the performance quality of the plurality of different network routes;
receive content data to be transmitted using the network, the content data including corresponding service level agreement (SLA) criteria; and
schedule delivery of the content data based on the prediction, the delivery identifying a subset of network routes used to transmit the content data that satisfies the SLA criteria of the content data.

15. The system of claim 14, wherein the performance quality for each of the plurality of different network routes is based on key performance indicator (KPI) parameters.

16. The system of claim 15, wherein the KPI parameters include one or more of jitter, loss, or latency.

17. The system of claim 16, wherein characterizing the performance quality of the plurality of different network routes comprises:
monitoring the plurality of different network routes over the pre-determined period of time based on the KPI parameters;
identifying a performance for the plurality of different network routes over the pre-determined period of time based on each of the KPI parameters; and
aggregating the performance of the plurality of different network routes over the pre-determined period of time, the characterization of the performance quality based on a highest class of content and the corresponding SLA criteria that is satisfied for each of the KPI parameters used.

18. The system of claim 14,
wherein,
the SLA criteria correspond to different classes of content each having a requisite performance requirement,
a first class has a strictest requisite performance requirement, and
each subsequent class has less strict requisite performance requirement with respect to a previous class.

19. The system of claim 14, wherein the stored instructions further cause the system to:
detect an anomaly in the network, the anomaly causing one or more of the plurality of different network routes associated with the scheduled delivery of the content data to no longer satisfy the SLA criteria; and
update the delivery to identify a different subset of network routes used to transmit the content data to satisfy the SLA criteria of the content data.

20. The system of claim 14, wherein the prediction is generated using machine learning.
